(19) United States
(12) Patent Application Publication
(10) Pub. No.: US 2026/0091997 A1
(43) Pub. Date: Apr. 2, 2026

(54) SYSTEMS AND METHODS FOR PURIFYING AQUEOUS FLUIDS

(71) Applicant: CHEMTREAT, INC., Glen Allen, VA (US)

(72) Inventors: Robert RABE, Tuscon, AZ (US); Vladimir DJUKANOVIC, Glen Allen, VA (US)

(73) Assignee: CHEMTREAT, INC., Glen Allen, VA (US)

(21) Appl. No.: 19/345,958

(22) Filed: Sep. 30, 2025

Related U.S. Application Data
(60) Provisional application No. 63/701,723, filed on Oct. 1, 2024.

(51) Int. Cl. C02F 1/56; C02F 1/52; C02F 101/20

(52) U.S. Cl. CPC C02F 1/56; C02F 1/5209; C02F 2101/203; C02F 2201/005

(57) ABSTRACT

This disclosure relates to systems and methods for purifying water, such as produced water used in fracking operations, by using an aqueous brine composition with a flocculant to separate and remove solids from the water. The aqueous brine composition can include a flocculant polymer that is partially hydrated in and suspended or dispersed in the aqueous brine composition. The aqueous brine composition can be added directed to the water without prior dilution, or with only minimal dilution.

### CROSS-REFERENCE TO RELATED APPLICATIONS

This application claims the earlier filing date benefit of U.S. Provisional Application No. 63/701,723, filed on October 1, 2024. The entirety of this prior application is incorporated by reference herein.

### TECHNICAL FIELD

The general field of this disclosure relates to systems and methods for treating aqueous fluids with an aqueous brine composition that includes a flocculant to purify the aqueous fluid, e.g., in a dissolved air flotation (DAF) process that produces purified water that can be stored or recycled for later use. The flocculant polymer may be partially hydrated and either suspended or dispersed in the aqueous brine composition. The systems and methods described herein are particularly useful for treating aqueous fluids used in hydraulic fracking operations, but may also be used to purify aqueous fluids used in refineries, power-plants, general water treatment facilities, etc.

### BACKGROUND

Hydraulic Fracturing or "Fracking" is a process that involves using water, chemicals and sand to extract products, including but not limited to natural gas or oil, from underground rock formations. This is done by blasting a mixture of the fracking-fluid into formations and crevices at high pressures in order to crack the rock formations and trigger the release of trapped oil and gas to the surface. In fracking operations, a thick polymer is typically added to water with sand and injected into a well under pressure to keep the formations open. This mixed water is known as fracking-water or fracking-fluid. The fracking-fluid settles in the well for an extended period of time, typically a period of months. The fracking-fluid is then induced to flow back up the tubing and now includes a mixture of water, oil, and gas -- this mixture is referred to as produced water. The saleable products need to be separated from the produced water, and the water is purified for later reuse, often in a central water treatment system. The central water treatment system can also receive and treat produced water that returns to the surface during oil and gas production when the well is active. The central water treatment system can receive produced water from multiple well heads.

The produced water received at the central water treatment system is typically purified in one or more separation processes, including but not limited to centrifuges, weir settling tanks, equalization tanks, and Dissolved Air Flotation (DAF) tanks. Existing processes use a relatively large volume of water in order to achieve the desired results.

In many of the existing systems, the central water treatment system at issue is an above-ground system that includes one or more large equalization (EQ) tanks (which may comprise stages including but not limited to weirs, mixers and flight collectors) to settle larger solids and produce more homogenized water. Oil production is often separated at the well-head, produced water is sent through the pipeline and residual free oil floats to the top of EQ tank, aboveground storage tank (AST), clarifier, weir or other storage tank from which the oil is skimmed and separated from the produced water. The produced water will still commonly contain soluble hydrogen sulfide (H2S) and soluble iron, which can precipitate as iron sulfide. This produced water is then fed to one or more dissolved air flotation (DAF) tanks. An oxidizing agent can be added after the EQ tank in order oxidize and drive iron out of solution, and to convert iron sulfide into iron hydroxide and elemental sulfur or soluble sulfate. The oxidizing agent can include peroxide or peracids, for example. The residual oil and iron precipitates can then be captured in the DAF to purify the water.

A flocculant polymer is added to the water upstream of the DAF tank(s). This flocculant attaches to smaller particles and causes them to aggregate, effectively increasing the size and buoyancy of the particles. The DAF tanks operate by dissolving air in the water under pressure in the form of micro-bubbles, which causes the aggregated particles to float on top of the tank. These particles can then be skimmed off the surface with a rake, often in the form of flight collectors, and then the clean water is sent to a holding area.

In current practices, different forms of flocculant polymer have been used, but most typically the flocculant polymer is an oil-in-water emulsion in which the polymer is emulsified with surfactants in a continuous phase of water. In the emulsion form, the polymer is wound up, and fresh water must be used to dilute and unwind the polymer molecule in order to make it an effective flocculant prior to adding the polymer to the water that is being treated. For example, the emulsion may include a mixture of approximately 30 % solids, and it needs to be diluted 100 or 200 fold by volume so that the polymer effectively unwinds. Thus, 100 gallons of water may be added to every 0.5 to 1 gallons of emulsion polymer, and then the diluted polymer is added to the water stream upstream of the DAF tank(s). This dilution process is referred to as a "makedown" process. This type of extensive makedown process is not preferred since it is time consuming and fresh water is often very scarce at fracking locations.

### SUMMARY

In view of the above, the inventors have discovered that an aqueous brine composition with a flocculant polymer may be used to achieve comparable results in purifying the water without needing a substantial makedown process. One embodiment involves a method for treating water. The method includes providing an aqueous brine composition that includes a flocculant polymer. This aqueous brine composition is added to a water stream that includes suspended solids. The suspended solids in the water stream aggregate with the flocculant polymer that was originally contained in the aqueous brine composition. The aggregated solids can be separated from the water stream to provide a purified water stream.

Another embodiment involves a system for purifying water. The system comprises a water stream that includes suspended solids, a polymer injection system designed to inject an aqueous brine composition, and a separation unit that is configured to receive the water stream. The polymer injection system in this system for purifying wastewater includes both a container and a dosing pump. The container holds an aqueous brine composition, which includes a flocculant polymer. The dosing pump is configured to receive the aqueous brine composition from the container and pump the aqueous brine composition to the water stream. The separation unit that is configured to receive the water stream is further configured to cause the suspended solids in the water to aggregate with the flocculant polymer, originally contained in the aqueous brine composition, and separate the aggregated solids from the water stream to provide a purified water stream.

### BRIEF DESCRIPTION OF THE DRAWINGS

The accompanying drawings, which are incorporated in and from a part of the specification, illustrate several embodiments of the invention wherein

FIG. 1 is a schematic diagram of centralized water treatment system in a fracking operation.

FIG. 2 is a perspective view of a polymer injection system for adding an aqueous brine composition to the water treatment system.

FIG. 3 is a perspective view of a polymer injection device that adds the aqueous brine composition to the water treatment system.

FIG. 4 is a schematic diagram of a system for automating the dosing of an aqueous brine composition in the water treatment system.

FIG. 5 is an exemplary flowchart showing a logic structure for automatically controlling the polymer dosing in the water system.

### DETAILED DESCRIPTION OF EMBODIMENTS

This disclosure relates to apparatuses, methods and systems for purifying aqueous fluids by using an aqueous brine composition with a flocculant polymer. More specifically, as described in detail below, aqueous fluids that are used in fracking operations can be purified with a DAF unit, or other separation device, in which the brine composition is added to the aqueous fluid as a flocculant. A significant advantage of the invention is that the aqueous brine composition does not require a significant amount of diluent water in a makedown process, and in some embodiments can be directly injected into the water treatment system without any prior dilution.

As used herein, "aqueous" refers to a composition that is at least 30 wt. % water. A "brine" as used herein refers to a composition that includes at least 2 percent by weight (2 wt.%) of an inorganic salt. The aqueous brine composition preferably includes from 3 to 30 wt.% of the salt, or from 5 to 20 wt. % the salt. The salt can include, for example calcium chloride, magnesium chloride, sodium chloride, etc. The aqueous brine composition can include from 10 to 60 wt. % water or from 20 to 40 wt. % water, for example.

The flocculant polymer can be a polymer with anionic repeating units, for example. The flocculant polymer can be an acrylamide polymer that includes acrylamide repeating units. The acrylamide polymer can also be an acrylamide copolymer with one or more repeating units in addition to the acrylamide repeating units, such as carboxylic acid repeating units (e.g., from monomers such as acrylic acid, methacrylic acid, etc.), acrylamide tertiary-butyl sulfonic acid (ATBS) (also known as 2-acryamido-2-methyl-1-propanesulfonic acid (AMPS ®)), or other comonomers. The composition can include the polymer in an amount of from, for example, 5 to 50 wt.%, or from 20 to 45 wt. %. The amount of flocculant polymer in the aqueous brine composition can be selected based on the application and the amount of precipitated solids that are expected to be removed in the DAF.

The aqueous brine composition may further comprise a stabilizing compound that prevents the flocculant polymer from fully dissolving in the brine composition. This can cause the polymer to become at least partially suspended in the aqueous brine composition in the sense that it is partially dissolved and some of the acrylamide units and/or comonomer units are hydrated, but others portions are blocked from being hydrated (i.e., it is partially hydrated) by the stabilizing compound. The stabilizing compound can include a cationic compound. The cationic moiety of the stabilizing compound can attach to anionic moieties on the flocculant polymer and prevent the polymer from solubilizing in the water of the aqueous brine. The cationic compound can be a quaternary ammonium compound, including but not limited to a choline salt or benzalkonium chloride. The aqueous brine composition can include the stabilizing compound in an amount of from 5 to 55 wt.%, or from 15 to 50 wt.%, for example.

In embodiments, at least 50 wt.% of the polymer component in the aqueous brine composition is suspended in the brine composition as described above, and preferably at least 90 wt.% or 95 wt.%. Likewise, the aqueous brine composition preferably includes no emulsified polymers or only insignificant amounts of emulsified polymers (e.g., less than 5 wt.% of the polymer component in the aqueous brine composition).

The aqueous brine composition can also include a dispersion agent that disperses the flocculant polymer and homogenizes the brine composition. The dispersion agent can include guar gum or xantham gum, for example.

Suitable compositions for use with embodiments of this invention are described in U.S. Patent No. 11,926,712, the entirety of which is incorporated by reference herein.

The use of an aqueous brine composition in which the polymer is partially suspended allows for a relatively concentrated polymer composition to be directly added to the water that is processed in the DAF because when it contacts the fresh water the polymer will go into the solution more easily and, unlike emulsion polymers that are used as flocculants, does not need substantial amounts of diluent water to uncoil the polymer. Thus, methods described herein can involve either (i) adding the aqueous brine composition directly to the water stream requiring treatment without any prior dilution, or (ii) by diluting the aqueous brine composition by less than 5 fold, less than 2 fold, or less than 1.5 fold in certain exemplary embodiments. As indicated above, it was discovered in connection with this disclosure that the aqueous brine compositions can act as effective flocculants without requiring any substantial makedown process.

This is a significant advantage. By way of example, in some water treatment systems for fracking operations the DAF tank may receive approximately 120000 US Fluid Barrels per day of water that may require approximately 35 gallons of the aqueous brine composition that can be fed directly into the water. In contrast, when using comparable amounts of an emulsion polymer, approximately 7,000 gallons of water per day must first be added to the emulsion polymer prior to injecting the polymer into the system to unwind the polymer and render it effective as a flocculant. This makedown process is time consuming and expends water resources, which are often scarce in remote fracking locations.

The use of the aqueous brine composition as described herein is also much more efficient than the emulsion polymer because the suspended polymer unravels or unwinds to a higher degree than is feasible with an emulsion polymer and thus is a more efficient flocculent polymer. For example, an emulsion polymer has a substantial portion that remains wound or coiled even after the makedown process. The polymer suspension product described herein can be dosed at a lower dose than the emulsion polymer while achieving the same flocculent effect. For example, the aqueous brine composition described herein can be added to the water so that the flocculant polymer is present at a concentration of, for example, from 0.1 ppm to 25 ppm, from 0.2 ppm to 10 ppm, or from 0.5 to 5 ppm.

Another advantage of the present disclosure is that the aqueous brine composition has a lower freezing point than the emulsion polymer (less than 10℉ versus approximately 40℉ respectively). Accordingly, where users would ordinarily need to insulate the lines to accommodate emulsion polymer solutions in colder environments, they would not need to insulate them when using the brine polymer composition, apart from very cold environments.

Yet another advantage of the aqueous brine composition is that it uses less organics than the emulsion polymer, thus lowering the total organic content (TOC) that is added to the water which has environmental benefits.

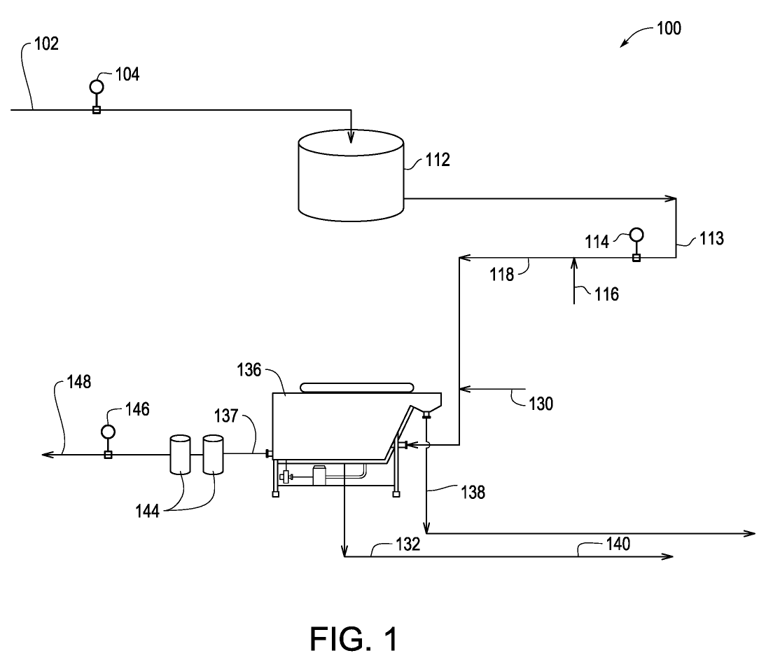

FIG. 1 represents an exemplary embodiment of a water treatment plant 100 comprising an upstream source of fluid, in this case produced water 102 which is measured for properties including but not limited to flow-rate or composition by a sensor 104. This stream 102 is then sent to a settling system in this case an equalization (EQ) tank 112, to allow for the settling and separation of heavier solids, including but not limited to grit, sand, dirt and anthracite, and to allow for the separation of residual oil products which will float on top of the water. In some embodiments the produced water 102 may be pre-dosed with an oxidizing agent such as hydrogen peroxide before being sent to equalization tank 112. In other embodiments, two or more settling tanks can be used in parallel to settle and separate heavier solids. The effluent water 113 from this process may then be measured again with sensor 114 before being dosed with hydrogen peroxide stream 116. The water stream dosed with hydrogen peroxide 118 is sent to a Dissolved Air Flotation (DAF) process where it is injected with an aqueous brine composition with an acrylamide flocculant polymer 130, as described above, in amounts of approximately 0.5 ppm to 5 ppm of the flocculant polymer. In this embodiment, the system 100 includes no makedown process for the aqueous brine composition 130, and the composition is injected into water stream 118 without prior dilution. The aqueous brine composition can be continuously dosed into the water stream, or can be dosed intermittently or periodically or in response to sensed characteristics of the water from one or more sensors/meters in the system 100.

The resultant fluid stream with the flocculant polymer is then fed to a DAF tank 136. The DAF causes flocculant to bond with and aggregate lighter solids to form larger suspended solids that are discharged as suspended sludge/solids 138, and further includes effluent drainage for pumping settled solids or other heavy products to solids processing 132. These effluent solids streams may be combined and discharged to a cake mix or sludge 140. The cleaned water effluent 137 may be further passed through one or more filters 144 and the flow rate and/or composition can again be measured by sensor 146 and discharged as cleaned water effluent 148. The system can alternatively include two or more DAF processes that are arranged in parallel to treat a higher volume of water.

The quality of the effluent water 148 can be monitored and the treatment system 100 controlled to ensure that the water does not exceed threshold limits of contaminants. In this regard, the treated water should generally be treated to have one or more of the following characteristics: less than 5 parts per million (ppm) iron, a turbidity of less than 20 ppm, total suspended solids of less than 50 ppm, no detectable oil, no detectable fats, no detectable grease, and hydrogen sulfide composition of less than 5 ppm. The cleaned water effluent 148 can then be sent to storage or recycled into the system, e.g., for hydraulic fracking fluid, or can be disposed in a salt water disposal well, etc.

In other embodiments, other separation processes that use a flocculant polymer can be used instead of or in addition to the one or more DAF tanks. For example, the water could be purified by combining the aqueous brine composition and water in a flocculation tank where the flocculant polymer causes the suspended particles to clump together to form flocs, which can be removed. This could also be done in weir tanks (with baffles), clarifiers, or other storage tanks as an alternative to the one or more DAF tanks.

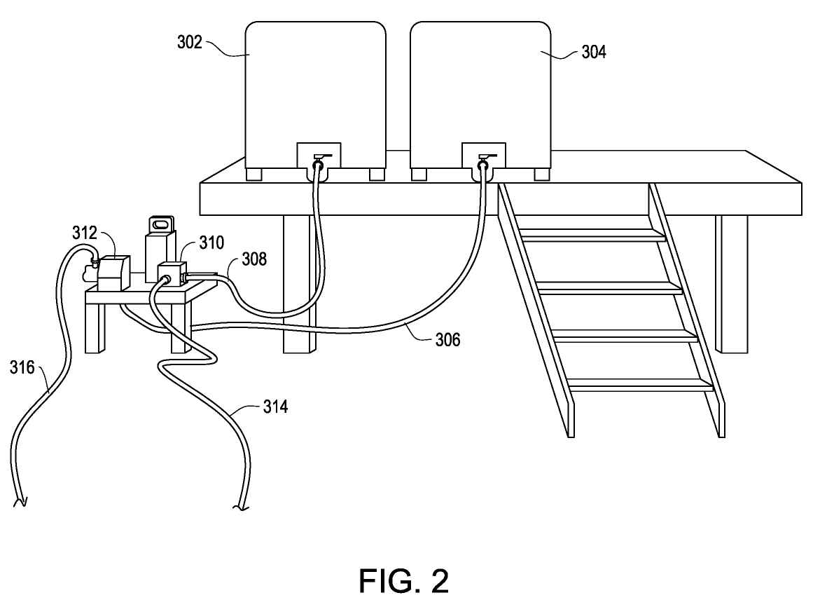

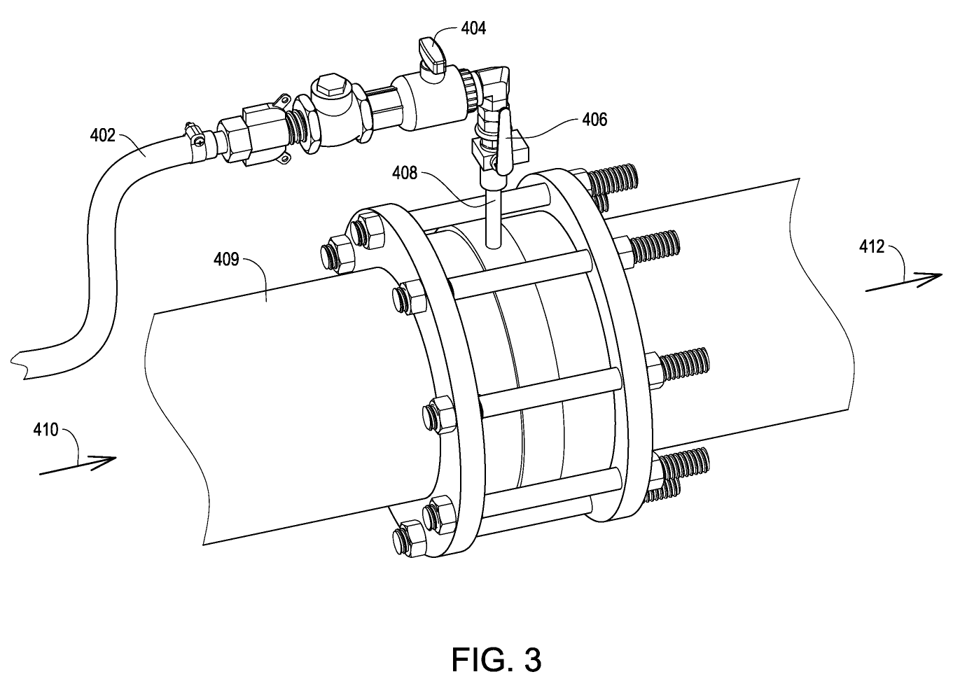

FIG. 2 is a perspective view showing the set up for injecting the aqueous brine composition into the water stream that is being treated. FIG. 2 illustrates two polymer tanks 302, 304, which each contain the aqueous brine composition. Each tank 302, 304 is connected to an effluent line 306, 308 which are fluidly connected to dosing pumps 310, 312. The dosing pumps 310, 312 control the dosing of the aqueous brine composition to injection lines 314, 316, which are further connected to an injection quill as discussed in connection with FIG. 3 below. In some embodiments, dosing pumps can include one or more progressing cavity pumps, although any type of pump or dosing mechanism can be used that is effective to add the aqueous brine composition to the water. The progressing cavity pumps may comprise a screw drive, which can facilitate continuous dosing. Also, progressing cavity pumps can maintain a sufficient back pressure that can prevent the nozzle or injection port from becoming clogged due to polymerization that may occur at the tip or exit point. In this embodiment, the system includes two polymer tanks 302, 304 to enable ongoing dosing of the aqueous brine composition while one of the tanks is serviced or refilled. In other embodiments, only a single tank may be used or more than two tanks can be used.

FIG. 3 is illustrates an injection system by which the aqueous brine composition is dosed into the water stream 410. Injection line 402 includes the aqueous brine composition that has been dosed by dosing pump upstream. The injection line 402 is connected to a system of valves including but not limited to one or more globe valves 404 and ball valves 406 which are in turn connected through a quill 408 that is inserted into pipe 409 that includes the water stream 410. The quill 408 can be inserted so that the exit port or nozzle of the quill 408 is submerged in the water stream 410 to thereby cause the dosed polymer composition to be immediately mixed with the water stream 410 upon exiting the quill 408. The resultant mixture may then continue as effluent 412 to be used in a purification process including but not limited to a DAF tank.

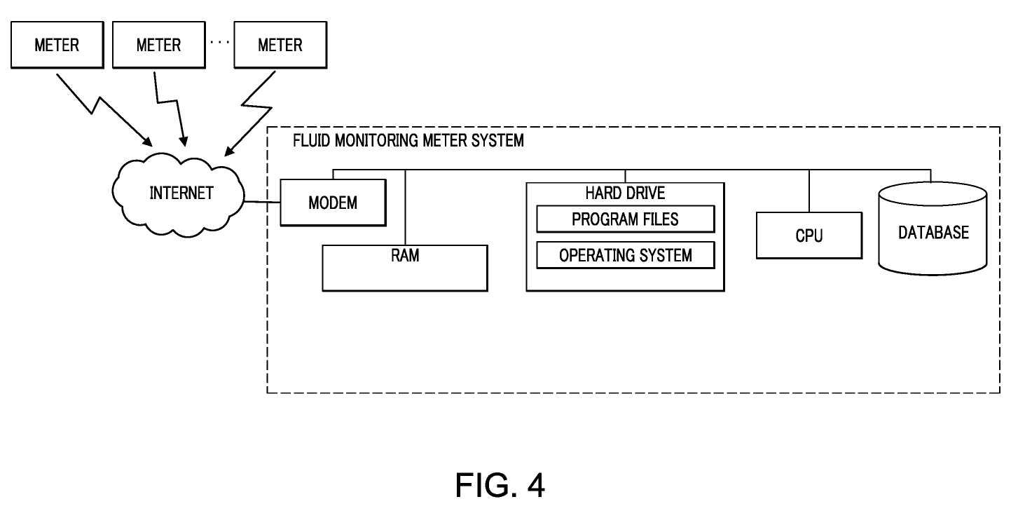

In some embodiments, the dosing of the aqueous brine composition can be automated based on one or more sensed parameters of the water system, e.g., flow rate, compositional measurements (e.g., total suspended solids, iron content, pH, concentration of polymer, etc.) that are measured by meters or probes (e.g., as described in FIG. 1). The meters or probes can be positioned upstream of the injection site of the aqueous brine composition or downstream of such an injection site, e.g., in one of the effluents of the DAF unit. FIG. 4 is an exemplary schematic diagram showing a system for automating the dosing of the aqueous brine composition. As can be seen in FIG. 4, one or more meters are positioned in the water system to measure at least one property of the water. The meters can send signals that are indicative of the measured properties through a communication network (e.g., Wi-Fi, Bluetooth, Internet, Intranet or near field communication) to a computer systems comprising a controller with a CPU or other processor that can determine the amount of dosing of the aqueous brine composition based on the measured properties. The computer system can include memory (Hard Drive; RAM) that stores program files for executing programs that can calculate the dosing of the polymer composition based on the measured data, e.g., flow rate or composition. The computer system can generate control signals based on the determined amount of dosing and send the control signals to the dosing pumps via the communication network to control the dosing of the polymer composition in the water system.

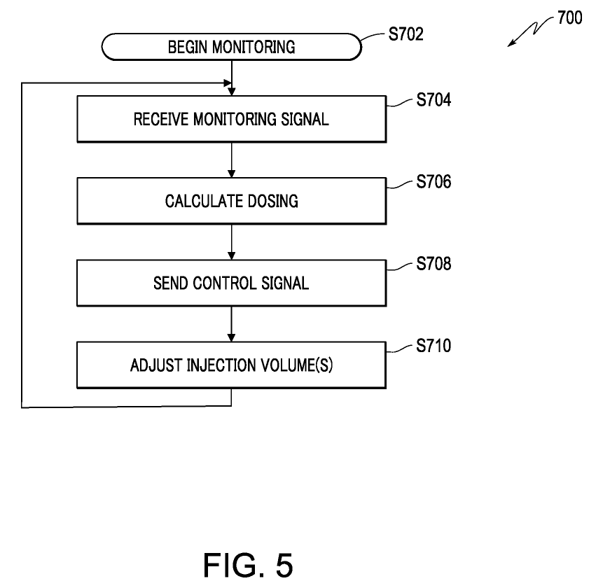

FIG. 5 is an exemplary flowchart showing an exemplary logic structure 700 for automatically controlling the aqueous brine composition injection. In this case the system begins monitoring S702 the influent water with a meter (e.g., a flow meter that measures the flow rate), receives a monitoring signal S704 from the meter that is indicative of the measured value, calculates the dosing of the aqueous brine composition S706 (e.g., based on the measured flow rate and a stored relationship between the flow rate and the dosing amount), sends a control signal S708 based on the determined dosing amount to the injection system (e.g., dosing pump and/or valves), and the injection system executes or adjusts the dosing volume of aqueous brine composition S710. In this example, the dosing was determined based on the measured flow rate upstream of the dosing injection site. In other embodiments, the dosing could be based on the flow rate and a composition of the water (e.g., TSS), and in other embodiments the dosing could be based on the efficacy of the DAF unit such as by measuring a composition of the DAF effluent.

It is understood that the various embodiments are shown and described above to illustrate different possible features of the invention and the varying ways in which these features may be combined. Apart from combining the different features of the above embodiments varying ways, other modifications are also considered to be within the scope of the invention. The invention is not intended to be limited to the embodiments described above, but rather is intended to be limited only by the claims set out below. Thus, the invention encompasses all alternate embodiments that fall literally or equivalently within the scope of these claims.

What is claimed is:

1. A method of purifying water, the method comprising:
providing an aqueous brine composition that includes a flocculant polymer;
adding the aqueous brine composition to a water stream that includes suspended solids;
treating the water stream by causing the suspended solids to aggregate with the flocculant polymer; and
separating the aggregated solids from the water stream to provide a purified water stream.

2. The method of claim 1, wherein the water stream is treated in a dissolved air flotation (DAF) unit to cause the suspended solids to aggregate with the flocculant polymer.

3. The method of claim 1, wherein the aqueous brine composition includes from 5 to 50 wt.% of the flocculant polymer.

4. The method of claim 3, wherein the aqueous brine composition is not diluted prior to adding it to the water stream.

5. The method of claim 3, wherein the aqueous brine composition is diluted less than 5 fold prior to adding it to the water stream.

6. The method of claim 1, wherein the flocculant polymer is an acrylamide polymer.

7. The method of claim 1, wherein the aqueous brine composition includes at least 3 wt.% of an inorganic salt.

8. The method of claim 1, wherein the flocculant polymer is partially hydrated and suspended or dispersed in the aqueous brine composition.

9. The method of claim 1, wherein the aqueous brine composition further includes a stabilizing compound that prevents the flocculant polymer from fully dissolving in the aqueous brine composition.

10. The method of claim 9, wherein the stabilizing compound is a cationic stabilizing compound.

11. The method of claim 1, wherein the suspended solids includes iron compounds.

12. The method of claim 1, herein before the step of adding the aqueous brine composition to the water stream, further comprising adding an oxidizing agent to the water stream to precipitate iron compounds in the water stream.

13. The method of claim 1, wherein the water stream includes produced water from a fracking operation.

14. The method of claim 1, further comprising using the purified water stream as a hydraulic fracking fluid in a fracking operation.

15. The method of claim 1, wherein before the step of adding the aqueous brine composition to the water stream, further comprising treating the water stream in a settling tank to settle and remove larger solid particles.

16. A system for purifying water that comprises:
a water stream that includes suspended solids;
a polymer injection system that includes:
(i) a container with an aqueous brine composition that includes a flocculant polymer; and
(ii) a dosing pump that is configured to receive the aqueous brine composition from the container and pump the aqueous brine composition through an injection port to add the aqueous brine composition to the water stream; and
a separation unit that is configured to receive the water stream that includes the aqueous brine composition, cause the suspended solids in the water to aggregate with the flocculant polymer, and separate the aggregated solids from the water stream to provide a purified water stream.

17. The system according to claim 16, wherein the separation unit includes one or more dissolved air flotation (DAF) tanks, one or more weir tanks, or one or more clarifiers.

18. The system according to claim 16, wherein the dosing pump is a progressing cavity pump.

19. The system according to claim 16, wherein the injection port is on a quill pipe that extends into the water stream so that the injection port is submerged.

20. The system according to claim 16, further comprising a controller that is configured to determine a dosing amount of the aqueous brine composition based on one or more measured properties of the water stream, and is configured to generate control signals to cause the pump to add an amount of the aqueous brine composition to the water stream based on the determined dosing amount.

21. The system according to claim 16, further including a holding pond that receives the purified water.
